(19) United States
(12) Patent Application Publication
(10) Pub. No.: US 2025/0371976 A1
(43) Pub. Date: Dec. 4, 2025

(54) Intelligent Traffic Visualization and Route Recommendation

(71) Applicant: International Business Machines Corporation, Armonk, NY (US)

(72) Inventors: Rong Zhao, Beijing (CN); Zhe Yan, Beijing (CN); Li Li Guan, Beijing (CN); Hao Xiang Wu, Beijing (CN); Li Bo Zhang, Beijing (CN)

(21) Appl. No.: 18/678,053

(22) Filed: May 30, 2024

(51) Int. Cl. G08G 1/0968; G06V 20/54; G08G 1/01; G08G 1/0969; G16Y 40/10

(52) U.S. Cl. CPC G08G 1/096844; G06V 20/54; G08G 1/0116; G08G 1/0133; G08G 1/0141; G08G 1/0145; G08G 1/096811; G08G 1/0969; G16Y 40/10; G06V 2201/08

(57) ABSTRACT

A computer implemented method analyzes traffic. A processor set receives traffic images from Internet of Things devices in real time. The processor set identifies a choke point of traffic congestion using the traffic images. The processor set generates a map of the traffic congestion with real time updates, wherein the map includes a visualization of the traffic congestion at a number of distances relative to the choke point of the traffic congestion. The processor set sends the map of the traffic congestion with the real time updates including at least one of a stage of the traffic jam or resolution information for the traffic jam to a navigation computing device.

### BACKGROUND

The disclosure relates generally to an improved computer system and more specifically to a computer system with intelligent traffic information visualization and route recommendations.

Users can employ route planning programs or tools to navigate from one location to another location. A user inputs a destination into a route planning program. This input can be an address or name of the location. The route planning program can use the current location of the user to determine an optimal route for traveling from the current location to the destination. Route planning programs can use traffic data to provide estimates of travel times. This traffic data is also used to determine any delays or congestion along the route. The route planning program also adjusts the recommended route to avoid traffic jams and minimize travel time.

The route planning program can recommend multiple routes for a user to select for use in traveling to the destination. These routes may have different distances, travel times, and traffic conditions. Once a route is selected, the route planning program can provide the user with turn by turn directions guiding the user to travel along the route. These instructions can also include instructions for turning or merging.

### SUMMARY

According to one illustrative embodiment, a computer implemented method analyzes traffic. A processor set receives traffic images from Internet of Things devices in real time. The processor set identifies a choke point of traffic congestion using the traffic images. The processor set generates a map of the traffic congestion with real time updates, wherein the map includes a visualization of the traffic congestion at a number of distances relative to the choke point of the traffic congestion. The processor set sends the map of the traffic congestion with the real time updates to a navigation computing device. According to other illustrative embodiments, a computer system and a computer program product for analyzing traffic are provided.

### BRIEF DESCRIPTION OF THE DRAWINGS

FIG. 1 is a block diagram of a computing environment in accordance with an illustrative embodiment;

FIG. 2 is a block diagram of a traffic environment in accordance with an illustrative embodiment;

FIG. 3 is an illustration of components for performing traffic analysis in accordance with an illustrative embodiment;

FIG. 4 is an illustration of an image analyzer in accordance with an illustrative embodiment;

FIG. 5 is an illustration of a traffic jam root cause analyzer in accordance with an illustrative embodiment;

FIG. 6 is an illustration of a traffic jam stage resolution identifier in accordance with an illustrative embodiment;

FIG. 7 is a block diagram of traffic jam stage information in accordance with an illustrative embodiment;

FIG. 8 is an illustration of real-time traffic information in accordance with an illustrative embodiment;

FIG. 9 is a flowchart of a workflow for traffic analysis in accordance with an illustrative embodiment;

FIG. 10 is a flowchart of a process for analyzing traffic in accordance with an illustrative embodiment;

FIG. 11 is a flowchart of a process for generating route guidance in accordance with an illustrative embodiment;

FIG. 12 is a flowchart of a process for generating route guidance in accordance with an illustrative embodiment;

FIG. 13 is a flowchart of a process for identifying a choke point of the traffic congestion in accordance with an illustrative embodiment;

FIG. 14 is a flowchart of a process for identifying a root cause of the choke point of the traffic congestion route guidance in accordance with an illustrative embodiment;

FIG. 15 is a flowchart of a process for determining traffic jam information in accordance with an illustrative embodiment;

FIG. 16 is a flowchart of a process for generating a visualization in accordance with an illustrative embodiment;

FIG. 17 is a flowchart of a process for sending traffic congestion information in accordance with an illustrative embodiment; and

FIG. 18 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

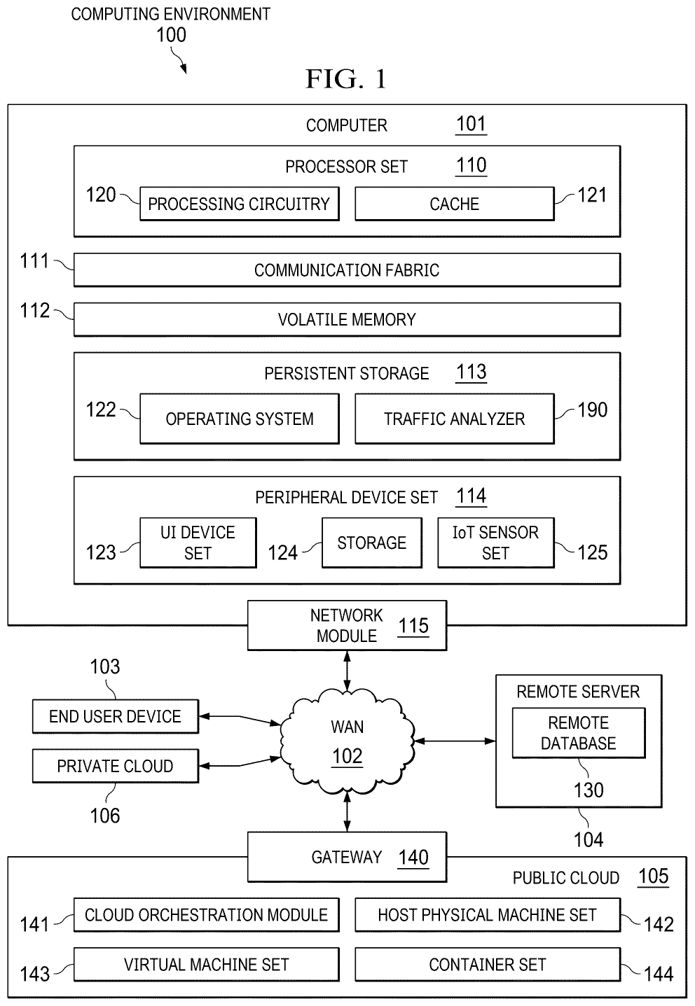

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as traffic analyzer 190. In addition to traffic analyzer 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and traffic analyzer 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in traffic analyzer 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in traffic analyzer 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. A service offering typically provides endpoints with which various customers interface. These endpoints are typically based on a set of APIs. One category of as a service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, user such as a driver may encounter a traffic jam. With this situation, the driver may want to know the root cause of the traffic jam and where the core traffic clogging point is located. This core traffic clogging point can also be referred to as a choke point in the traffic jam. This information can often be useful to the driver. For example, the driver may change lanes or take other actions rather than follow a route displayed with a map generated by a route planning program.

Current systems for reporting issues such as traffic jams, accidents, or other situations rely on users to make these reports. The user inputs a description and can upload a photograph. However, these types of actions can be difficult while the user is driving a car. For example, taking the time to enter details about the accident and to take a photograph of the traffic jam accident may be difficult to perform while driving. Further, as the vehicle passes the choke point of congestion it may be difficult to take photos for input information about the latest status of the traffic jam. It would be desirable to have a traffic reporting system that automatically obtains traffic information and reports this information to users in vehicles in real time. In other examples, the use can be a passenger or other person.

Thus, the illustrative embodiments provide a method, apparatus, system, and computer program product for analyzing traffic. In one illustrative example, traffic images from Internet of Things devices in real time. A choke point of traffic congestion is identified using the traffic images. A map of the traffic congestion with real time updates is generated. The map includes a visualization of the traffic congestion at a number of distances relative to the choke point. These distances can be at least one of before or after the chokepoint. The map of the traffic congestion with the real time updates is sent to a navigation computing device.

As used herein, a “number of” when used with reference items means one or more items. For example, a number of distances is one or more distances.

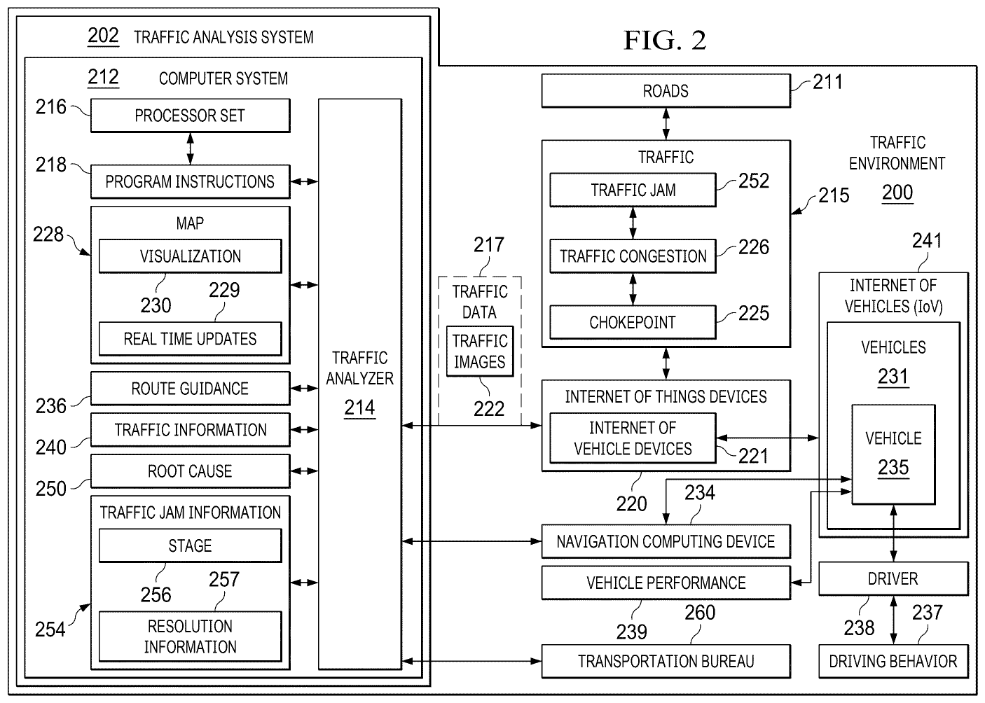

With reference now to FIG. 2, a block diagram of a traffic environment is depicted in accordance with an illustrative embodiment. In this illustrative example, traffic environment 200 includes components that can be implemented in hardware such as the hardware shown in computing environment 100 in FIG. 1. In this example, traffic analysis system 202 can operate to analyze traffic to identify issues such as congestion and traffic and provide recommendations.

In this illustrative example, traffic analysis system 202 comprises computer system 212 in traffic analyzer 214. Traffic analyzer 214 is located in computer system 212. Traffic analyzer 214 may be implemented using traffic analyzer 190 in FIG. 1.

Traffic analyzer 214 can be implemented in software, hardware, firmware, or a combination thereof. When software is used, the operations performed by traffic analyzer 214 can be implemented in program instructions configured to run on hardware, such as a processor unit. When firmware is used, the operations performed by traffic analyzer 214 can be implemented in program instructions and data and stored in persistent memory to run on a processor unit. When hardware is employed, the hardware can include circuits that operate to perform the operations in traffic analyzer 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

The phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units that can be implemented using processor set 110 in FIG. 1. The processor units can also be referred to as computer processors. When processor set 216 executes program instructions 218 for a process, processor set 216 can be one or more processor units that are in the same computer or in different computers. In other words, the process can be distributed between processor units in processor set 216 on the same or different computers in computer system 212.

Further, processor set 216 can include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

In this illustrative example, traffic analyzer 214 can analyze traffic 215. In this illustrative example, this analysis can be performed by receiving traffic data 217 from Internet of Things (IoT) devices 220. Internet of Things devices 220 includes a network of interconnected computing devices. These computing devices can include sensors and software. An Internet of Things device can communicate over a network such as the Internet using at least one of a wireless connection or a wired connection.

In this illustrative example, the Internet of Vehicles (IoV) 241 is a network of vehicles 231 equipped with sensors, software, and the technologies that mediate between these with the aim of connecting and exchanging data over the internet. Internet of Vehicle (IoV) devices 221 are Internet of Things (IoT) devices 220 designed and used with vehicles 231 in Internet of Vehicles 241. These devices can be located on a vehicle by being attached to, connected to, or integrated within a vehicle. These devices generate and can process information.

Vehicles 231 can include, for example, a car, an automobile, a truck, a motorcycle, a semi-truck, or other type of vehicle that can generate traffic data 217. In this example, internet of Things (IoT) devices 220 include at least one of a camera on a car, a tire pressure monitor, a radar sensor, or other devices that can be used on vehicles 231 in Internet of vehicles 241.

Internet of Things devices 220 can include these computing devices as well as other computing devices. For example, Internet of Things devices 220 can include at least one of a traffic camera, an electronic toll collection (ETC) device, a streetlight, a digital sign, a roadside sensor, or other device that can be located at or near the road for generating traffic data 217.

In this illustrative example, traffic data 217 includes traffic images 222 and can include other data. Traffic images 222 are photographs. These photographs are visual images captured using a sensor such as a camera. In these examples, traffic images 222 provide visualization of traffic 215 on roads 211. Roads 211 can include at least one of a highway, a street, a freeway, an avenue, or other types of roads.

Further, in this illustrative example, traffic data 217, including traffic images 222, is generated automatically without needing user input to generate this data. In other words, a user is not needed to generate traffic images 222 and upload those traffic images for use.

In this illustrative example, traffic images 222 can show the amount of traffic congestion 226 at different locations to driver 238. Further, traffic images 222 can be lane specific. These traffic images can be from the point of view of particular lanes. For example, Internet of Vehicle (IoV) devices 221 can generate traffic images 222 from the lanes in which the Internet of Vehicle devices 221 are traveling. Thus, traffic images 222 can provide a visualization of traffic 215 from the perspective of a particular lane based on the lane in which an Internet of Things device generating an image is located.

Traffic analyzer 214 receives traffic images 222 in traffic data 217 from Internet of Things devices 220 in real time. Traffic analyzer 214 identifies choke point 225 of traffic congestion 226 in traffic 215 using the traffic images 222. In this illustrative example, traffic analyzer 214 can identify choke point 225 by generating traffic information 240 from traffic images 222. Traffic analyzer 214 can identify choke point 225 of traffic congestion 226 from traffic information 240.

In this illustrative example, traffic analyzer 214 generates map 228 of traffic congestion 226 with real time updates 229. Map 228 includes visualization 230 of traffic congestion 226 at a number of distances relative to choke point 225. Further in this example, traffic analyzer 214 sends map 228 of traffic congestion 226 with real time updates 229 to navigation computing device 234. Map 228 is a real-time traffic data map that includes traffic data with real-time information such as real time updates 229.

Traffic analyzer 214 can generate visualization 230 of choke point 225 of traffic congestion 226 from a perspective of vehicle 235. This visualization can be in real time in which traffic images 222 used to provide visualization 230 is received and processed in real-time.

As depicted, vehicle is a vehicle in vehicles 231 in Internet of Vehicles 241. In this example, visualization 230 can be specific to a lane in which vehicle 235 is traveling. This visualization can be provided using traffic images 222 that are lane specific to different lanes based on the lanes in which Internet of Vehicle devices 221 generating traffic images 222 on vehicles 231 are located.

In this illustrative example, navigation computing device 234 display map 228 to a user. Navigation computing device 234 can take a number of different forms. For example, navigation computing device 234 can be selected from a group comprising a mobile phone, a laptop computer, a vehicle navigation system, or other suitable navigation computing device. The vehicle navigation system can be a vehicle 235 in which the user is located. This user can be, for example, a driver or passenger in vehicle 235.

Further, traffic analyzer 214 can identify root cause 250 of choke point 225 of traffic congestion 226 using traffic information 240. Root cause 250 can also be sent to navigation computing device 234.

Traffic analyzer 214 can also generate route guidance 236 for vehicle 235 taking into account choke point 225 of traffic congestion 226. Traffic analyzer 214 sends route guidance 236 to navigation computing device 234. This route guidance 236 can be sent with map 228 or separately from map 228.

In the illustrative examples, route guidance 236 can be displayed in conjunction with map 228. For example, route guidance 236 can show different routes on map 228 that can be used to reach a destination.

In this illustrative example, traffic congestion 226 can be traffic jam 252. In one illustrative example, traffic jam 252 can be a significant slowdown in be reduction in vehicle speed and traffic flow as compared to normal conditions. This slowdown could include situations where vehicles are moving at a substantially slower pace than the posted speed limit or when traffic becomes so congested that vehicles are forced to stop or crawl along the road for an extended period. A significant amount of congestion can be severe enough to at least one of impede the smooth movement of traffic or cause considerable delays for a driver. This type of congestion can also be referred to as a traffic jam.

In this depicted example, traffic analyzer 214 determines traffic jam information 254 using the traffic images 222. With this example, traffic jam information 254 comprises at least one of stage 256 of the traffic jam 252 or resolution information 257 for traffic jam 252. Traffic analyzer 214 sends traffic jam information 254 to navigation computing device 234.

In this illustrative example, traffic analyzer 214 can generate route guidance 236 for vehicle 235 taking into account choke point 225 of traffic congestion 226 and at least one of driving behavior 237 of a driver 238 of vehicle 235 or driver 238 of vehicle 235.

Driving behavior 237 can take a number of different forms. For example, driving behavior 237 can be patterns of behavior exhibited by driver 238 while operating vehicle 235. These patterns of behavior can be how driver 238 accelerates, selects driving speeds, brakes, changes lanes, follows traffic rules, uses turn signals, responds to driving conditions, or other behaviors when operating vehicle 235.

Vehicle performance 239 can include the parameters for vehicle 235. For example, vehicle performance 239 can include at least one of vehicle type, tire pressure, low oil level, battery charge, engine temperature, or other parameter relating to the performance of vehicle 235. Vehicle performance 239 can also include parameters regarding the health of vehicle 235. For example, malfunctions or other issues can also be included in vehicle performance 239.

In these illustrative examples, traffic analyzer 214 can also send information to other destinations in addition to navigation computing device 234. For example, traffic analyzer 214 can send choke point of traffic congestion information and map 228 to transportation bureau 260. In this illustrative example, transportation bureau 260 is a government entity that monitors traffic conditions, detects incidents, and can make dynamic adjustments to optimize traffic flow and reduce congestion. For example, transportation bureau 260 can use this information to perform actions selected from at least one of modifying traffic signal timing, implementing lane closures, implementing detours, providing real time updates on signage, or other suitable actions.

Thus, in the illustrative example, traffic analyzer 214 can receive traffic data 217 in real time in a manner that enables identifying choke point 225 and root cause 250 for traffic congestion 226. This traffic congestion can be, for example, traffic jam 252 on roads 211.

When visualization 230 takes the form of traffic images 222, drivers can be provided with a better user experience. The sharing of traffic images 222 to drivers in real time as received from Internet of Things devices 220 can enable drivers to make better decisions and to perform driving adjustments more efficiently with respect to routes and lanes.

For example, the root cause of traffic congestion 226 such as traffic jam 252 along with chokepoint 225 can be provided to driver 238. This information can be used to adjust the lane in which the driver is using or take another action such as changing routes. Further, visualization 230 including traffic images 222 in real time can provide driver 238 an ability to ascertain traffic congestion 226 more quickly as compared to looking at graphical elements such as icons and color to represent traffic 215.

In these examples, computer system 212 can be configured to perform at least one of the steps, operations, or actions described in the different illustrative examples using software, hardware, firmware, or a combination thereof. As a result, computer system 212 operates as a special purpose computer system in which traffic analyzer 214 in computer system 212 enables analyzing traffic in a manner that enables providing timely information to drivers for route selection or planning. In these illustrative examples, traffic analyzer 214 performing steps in the illustrative examples can result in a practical application for the traffic analysis. For example, results such as map 228, traffic information 240, traffic jam information 254, route guidance 236, and other information generated by traffic analyzer 214 analyzing traffic data 217 can be sent to navigation computing devices for use in a practical application to perform real-world actions with respect to traffic congestion 226 in traffic 215. Further, the information can also be used by other entities in a practical application to manage traffic congestion 226.

The illustration of traffic environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, other maps in addition to or in place of map 228 with visualization 230 having real time updates 229 can be generated and sent to other navigation computing devices in addition to or in place of navigation computing device 234. In this example, route guidance 236 can be generated for other navigation computing devices in other vehicles other than navigation computing device 234 in vehicle 235. With other vehicles in vehicles 231, route guidance 236 is tailored to the current location of vehicles 231 and destinations for vehicles 231.

Further, route guidance 236 can also vary for the same location or destination depending on driver behavior for particular driver of the vehicle 235. Additionally, navigation computing device 234 in vehicle 235 may be for a user such as a passenger rather than a driver.

As another example, one or more choke points can be present in addition to choke point 225 in traffic congestion 226. Traffic analyzer 214 can analyze each one of these choke points that are identified to generate at least one of maps, route guidance, or other traffic information for users such as drivers, passengers, or other persons that may be able to use this information.

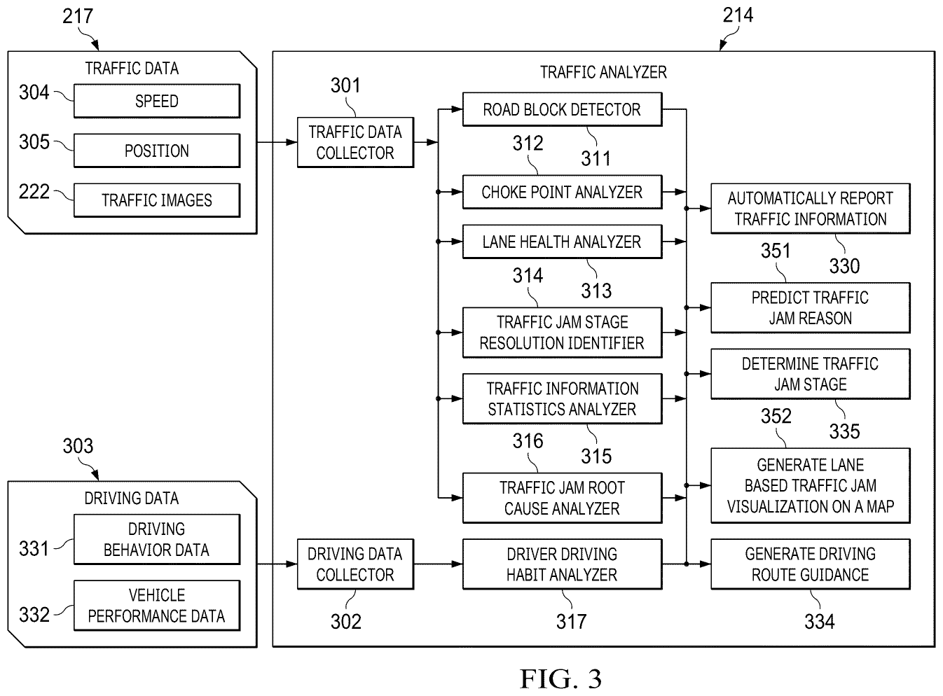

With reference next to FIG. 3, an illustration of components for performing traffic analysis is depicted in accordance with an illustrative embodiment. In the illustrative examples, the same reference numeral may be used in more than one figure. This reuse of a reference numeral in different figures represents the same element in the different figures.

An example of components in traffic analyzer 214 are depicted. In this illustrative example, traffic data collector 301 and driving data collector 302 are components that collect data for performing traffic analysis. As depicted, traffic data collector 301 collects traffic data 217 from Internet of Things devices 220 including Internet of Vehicle devices 221 on vehicles 231 in traffic 215. In this example, traffic data 217 collected by traffic data collector 301 includes speeds 304, positions 305, and traffic images 222.

In this example, driving data collector 302 collects driving data 303. This driving data includes driving behavior data 331 and vehicle performance data 332 for vehicle 235 in traffic 215.

In this example, driving behavior data 331 comprises data for driving patterns for driver 238 of vehicle 235. These patterns in this data can be analyzed to determine how driver 238 accelerates, selects driving speeds, brakes, changes lanes, follows traffic rules, uses turn signals, responds to driving conditions, or other behaviors when operating vehicle 235.

Vehicle performance data 332 can include various parameters for vehicle 235. For example, vehicle performance 239 can include at least one of vehicle type, vehicle age, tire pressure, a battery charge level, a brake fluid pressure, an engine temperature, or other parameter relating to the performance of vehicle 235.

Traffic data 217 is analyzed by a number of different components in traffic analyzer 214. In this example, this traffic data is analyzed by roadblock detector 311, choke point analyzer 312, lane health analyzer 313, traffic jam stage resolution identifier 314, traffic information statistics analyzer 315, and traffic jam root cause analyzer 316.

In these illustrative examples, these components in traffic analyzer 214 are comprised of at least one of software or hardware components and can be implement processes in the illustrative examples. In one illustrative example, one or more of these components can be implemented using a machine learning model.

A machine learning model is a type of artificial intelligence model that can learn without being explicitly programmed. A machine learning model can learn using training data input into the machine learning model. The training data can also be referred to as a training dataset.

The machine learning model can learn using various types of machine learning algorithms. The machine learning algorithms include at least one of a supervised learning, an unsupervised learning, a feature learning, a sparse dictionary learning, an anomaly detection, a reinforcement learning, a recommendation learning, or other types of learning algorithms. Examples of machine learning models include an artificial neural network, a convolutional neural network, a generative adversarial network (GAN), a sequence to sequence model, a variation auto encoder, a decision tree, a support vector machine, a regression machine learning model, a classification machine learning model, a random forest learning model, a Bayesian network, a genetic algorithm, and other types of models. These machine learning models can be trained using data and process additional data after training to provide a desired output.

In this illustrative example, roadblock detector 311 can detect various objects that may be located on a road. For example, roadblock detector 311 analyzes traffic images 222 to identify various objects that may be on a road. These objects can include, for example, a stalled vehicle, a throw out item, or other debris on the road. A throw out items can include, for example, a ladder, a chair, and other items that can be a hazard. Additionally, speeds 304 and positions 305 of other vehicles can be used to identify the location of the debris in addition to using traffic images 222.

In this example, choke point analyzer 312 identifies an area on a road where traffic flow has been impeded or restricted resulting in traffic congestion 226 with at least one of slowdowns or standstills in traffic flow. The amount of slowdown that would be of interest for traffic congestion 226 in choke point 225 can be based on different factors such as at least one of a capacity of the road, typical traffic patterns, local driving norms, speed limits, or other factors. For example, a reduction in lanes from an accident or construction can form a bottleneck that is choke point 225.

Lane health analyzer 313 identifies how well traffic flows in particular lanes on a road in roads 211 In this example, the flow can be determined based on traffic data 217. For example, traffic data 217 can be data that is analyzed to determine the distance between vehicles 231 and the speed of the vehicles 231.

The lane health for a lane can be based on the speed of traffic 215 in the lane relative to posted speeds. Different lanes may have different levels of health. The lane health can be expressed using labels such as numbers. For example, lane health can be from 1 to 5 with 1 being the best lane health. In another example, lane health can be expressed using labels such as poor, fair, good, and excellent.

Traffic jam stage resolution identifier 314 identifies the stage of a traffic jam. For example, stages of traffic jam 252 can be accident identified, waiting to be handled, rescue performed, transportation bureau handling, and road cleared. These stages can be used to determine route guidance 236. Further, this information can also be used to identify actions that need to be taken to resolve traffic jam 252. These actions can include, for example, requests for at least one of an ambulance, a paramedic, a law enforcement officer, tow truck, a cleanup crew, or other resources that can be used to resolve traffic jam 252.

In this illustrative example, traffic information statistics analyzer 315 analyzes traffic data 217 from different vehicles to determine a number of different statistics. These statistics can include at least one of a speed, a distance between vehicles 231, number of vehicles 231 in a lane, and other statistics.

Traffic jam root cause analyzer 316 determines root cause 250 of traffic congestion 226 such as traffic jam 252. This root cause can then be used by traffic jam stage resolution identifier 314 to identify actions to resolve traffic jam 252. In this illustrative example, root cause 250 can take a number of different forms. For example, root cause 250 can be at least one of an accident, a stalled vehicle, a debris, a lane reduction, an exit closure, or other causes.

In this illustrative example, driver driving habit analyzer 317 can use driving data 303 to determine driving behavior 237 for driver 238 of vehicle 235. For example, this behavior can include at least one of lane preference, preferred speeds, preference for driving distance, preference for faster speeds, braking habits, and other information on how driver 238 operates vehicle 235.

Vehicle performance data 332 can be used to determine vehicle performance 239 for vehicle 235. This information can be used to determine route guidance 236 that is specific to at least one of vehicle 235 or driver 238. For example, this driving behavior can include at least one of lane preference, speeds driven, preference for driving distance, preference for faster speeds, braking habits, and other information on how driver 238 operates vehicle 235. Vehicle performance 239 can be used to identify the maximum speeds that vehicle 235 can travel on roads 211.

Based on the analysis by these different components in traffic analyzer 214, a number of actions can be performed by traffic analyzer 214. For example, traffic analyzer 214 can perform actions selected from at least one of automatically report traffic information 330, predict traffic jam reason 351, determine traffic jam stage 335, generate lane based traffic visualization on a map 352, or generate driving route guidance 334.

In this example, automatically report traffic information 330 includes sending traffic information to transportation bureau 260. This information can also be sent to other vehicles in traffic 215.

Traffic analyzer 214 can predict traffic jam reason 351 using the root cause identified by traffic jam root cause analyzer 316. Determine traffic jam stage 335 can indicate the stage of the traffic jam. For example, with a traffic jam caused by an accident, these stages can include, for example, accidents identified, waiting to be handled, transportation Bureau handling accident, and road cleared.

In this example, generate lane based traffic visualization on a map 333 is an action that can involve identifying traffic images 222 for different lanes of traffic. These images can be associated with the lanes and used to provide a visualization of traffic 215 for different lanes on map 228.

Generate driving route guidance 334 can include identifying alternate routes in addition to the current route to a destination along which traffic jam 252 has been identified. The identification is used by generate driving route guidance 334 to generate route guidance 236. These route suggestions in route guidance 236 can include information such as distance, travel time, and other information associated with the different routes. In this illustrative example, route suggestions in route guidance 236 can be specifically customized for at least one of vehicle 235 or driver 238. These customizations can be based on at least one of vehicle performance 239 for vehicle 235 or driving behavior 237 for driver 238.

For example, some routes can be emphasized over other routes or routes can be selected based on driving behavior 237 and vehicle performance 239 determined using driving data 303. For example, route selections can be based on a preference identified in driving behavior vehicle 237 of driver 238 for avoiding toll roads. In another illustrative example, route selections can be based on determining whether driver 323 has a preference for driving at faster speeds or has a preference for driving shorter distances. In another example, a particular route can be selected based on the type of vehicle and the performance characteristics for that vehicle. For example, routes with slower speeds may be suitable for a vehicle that can only travel up to 50 mph. As another example, if the vehicle is a motorcycle, different routing options may be available for roads as compared to an automobile.

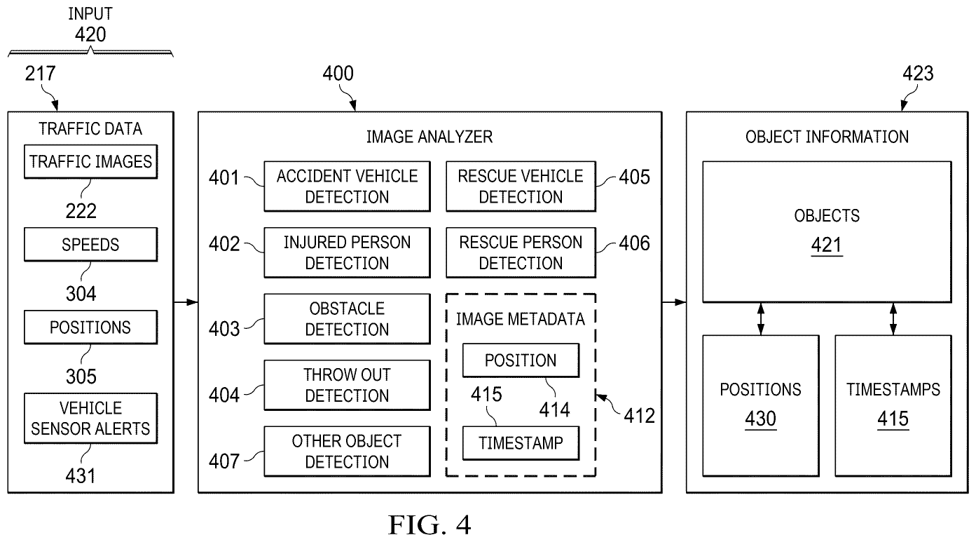

Turning next to FIG. 4, an illustration of an image analyzer is depicted in accordance with an illustrative embodiment. In this illustrative example, image analyzer 400 receives input 420 in the form traffic images 222 in traffic data 217 for analysis. Image analyzer 400 can perform a number of different types of analysis using traffic images 222 to identify objects 421 in object information 423. This analysis can also be performed using additional traffic data in input 420 such as speeds 304, positions 305, and vehicle sensor alerts 431 for vehicles 231.

For example, image analyzer 400 can identify objects 421 by performing accident vehicle detection 401, injured person detection 402, obstacle detection 403, throw out detection 404, rescue vehicle detection 405, rescue person detection 406, and other object detection 407. Objects 421 can include at least a vehicle involved in an accident, an injured person, an obstacle, an item thrown out on the road, and other debris. Further, objects 421 identified by image analyzer 400 can also include a rescue vehicle, a rescue person, and other types of objects.

Further, image analyzer 400 uses image metadata 412 to associate information with objects 421. For example, image metadata 412 includes position 414 and timestamp 415 for each of traffic images 222. This information can be associated with objects 421 identified in traffic images 222. For example, two vehicles are identified in an image as vehicles in an accident. Position 414 and timestamp 415 for that image can be associated with those two vehicles. Thus, object information can include positions 430 and timestamps 415 for objects 421. Timestamps 415 indicate when objects 421 are located at positions 430 in these examples.

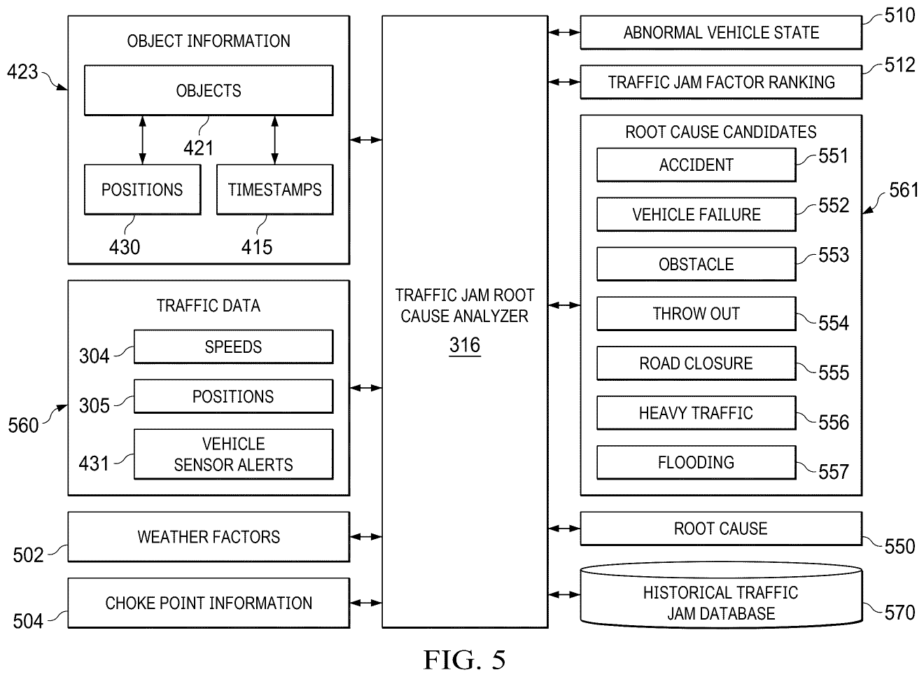

With reference next to FIG. 5, an illustration of a traffic jam root cause analyzer is depicted in accordance with an illustrative embodiment. In this illustrative example, an example of components used to implement traffic jam root cause analyzer 316 is shown in this figure. In this illustrative example, traffic jam root cause analyzer 316 determines root cause 550 using various inputs. For example, traffic jam root cause analyzer 316 receives object information 423 identifying objects 421 and positions 430 and timestamps 415 for objects 421 from image analyzer 400 in FIG. 4. Further, traffic jam root cause analyzer 316 also receives traffic data 217 comprising speeds 304, positions 305, and vehicle sensor alerts 431.

Additionally, traffic jam root cause analyzer 316 also receives other information used in determining root cause 550. In this depicted example, traffic jam root cause analyzer 316 receives weather factors 502 and choke point information 504.

For example, weather factors 502 can indicate flooding is present in a particular location. This flooding may be root cause 250 for the information about choke point 225. This information can include at least one of a lane, a position, related congestion, or other information about the choke point. Flooding can affect this information.

In this example, in determining root cause 550, traffic jam root cause analyzer 316 determines whether abnormal vehicle state 510 is present in one or more of vehicles 231 based on vehicle sensor alerts 431. A vehicle sensor alert is an alert generated based on some abnormal state in a vehicle. This state can be, for example, a low tire pressure, a low oil level, low brake fluid, anti-break locking system (ABS) activation, a transmission fluid leak, an engine malfunction, a low fuel level, or other state. These abnormal vehicle states can be used to determine the health of a vehicle. This information can be used to determine whether the vehicle may have issues on a road.

This determination can also be made using speeds 304 and positions 305. For example, a low tire pressure can indicate the presence of a flat tire in a vehicle in which the vehicle is not moving based on speeds 304 at a choke point identified for positions 305. This identification of abnormal vehicle state 510 can be used as a factor in determining root cause 550.

Traffic jam factor ranking 512 can be used by traffic jam root cause analyzer 316 to determine root cause 550. In this illustrative example, traffic jam factor ranking 512 can be implemented using a machine learning model that is trained to identify root cause 550. In this example, traffic jam factor ranking 512 uses these inputs along with abnormal vehicle state 510 to identify root cause 550.

In this illustrative example, traffic jam factor ranking 512 identifies root cause candidates 561 from object information 423, traffic data 217, weather factors 502, choke point information 504, and abnormal vehicle state 510. These root cause candidates can include one or more of accident 551, vehicle failure 552, obstacle 553, throw out 554, road closure 555, heavy traffic 556, flooding 557, and other suitable candidates.

Traffic jam factor ranking 512 also ranks or scores the impact of different candidate root causes to traffic congestion. Root cause 550 is identified based on the ranking or score for root cause candidates 561.

For example, obstacle 553 and throw out 554 will impact a driving speed for one or more lanes. Accident 551 and vehicle failure 552 can a lane or location on the road. Heavy traffic 556 may cause slow traffic but will not block the road. Each of these root cause candidates can be assigned a score such as from 10 to 1 with 10 being the highest influence on a traffic jam and 1 being the lowest influence on the traffic jam. The root cause candidates having the highest score is identified as root cause 550 for the traffic jam.

In response to determining root cause 550, traffic jam root cause analyzer 316 can automatically report the occurrence of the traffic jam with root cause 550. For example, this information can be reported to at least one of a transportation bureau, a towing company, a fire station, or other suitable entity.

In this illustrative example, traffic jam root cause analyzer 316 stores traffic data 560 and root cause 550 in historical traffic jam database 570.

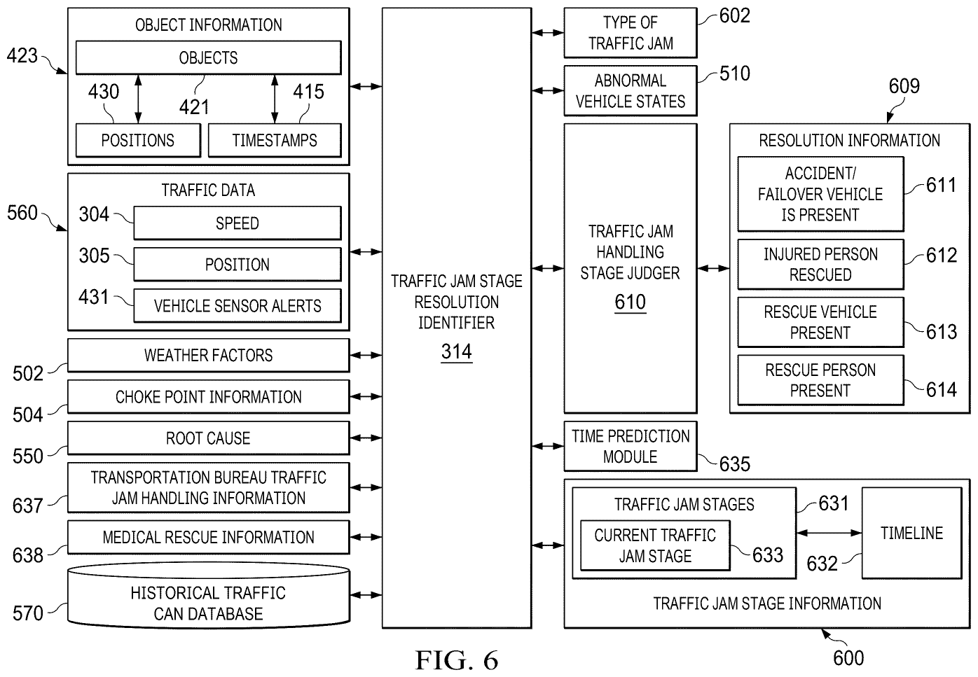

With reference to FIG. 6, an illustration of a traffic jam stage resolution identifier is depicted in accordance with an illustrative embodiment. In this illustrative example, an example of components used to implement traffic jam stage resolution identifier 314 is depicted in this figure.

A traffic jam can have multiple stages. In this example, traffic jam stage resolution identifier 314 determines traffic jam stage information 600 for a traffic jam. In this illustrative example, traffic jam stage resolution identifier 314 receives inputs for determining traffic jam stage information 600. These inputs include object information 423, identifying objects 421, positions 430 and timestamps 415 for objects 421 from image analyzer 400 in FIG. 4. Further, traffic jam root cause analyzer 316 also receives traffic data 217 comprising speeds 304, positions 305, and vehicle sensor alerts 431.

Additionally, traffic jam root cause analyzer 316 also receives other information that can be used to determine traffic jam stage information 600. For example, root cause 550 can be identified by traffic jam root cause analyzer 316 in FIG. 5.

In this illustrative example, traffic jam stage resolution identifier 314 uses root cause 550 to determine type of traffic jam 602. For example, type of traffic jam 602 can be an accident, a lane closure, debris on the road, flooding, or other types of traffic jams. Additionally, traffic jam stage resolution identifier 314 uses vehicle sensor alerts 431 to determine whether abnormal vehicle state 510 is present using vehicle sensor alerts 431. In this example, one or more vehicles may have abnormal states that may be used in determining traffic jam stage information 600.

Further, in this illustrative example, traffic jam handling stage judger 610 can identify resolution information 609 about the traffic jam using object information 423. This resolution information indicates what resources may be present to resolve the traffic jam. For example, traffic jam handling stage judger 610 determines whether at least one of accident/failover vehicle is present 611, injured person rescued 612, rescue vehicle present 613, rescue person present 614, or other suitable information for resolution information 609. In this example, an accident/failover vehicle is a designated vehicle for emergency services that can be used to resolve traffic jams.

With this information, traffic jam stage resolution identifier 314 identifies traffic jam stage information 630. This information includes traffic jam stages 631 and timeline 632 for traffic jam stages 631. Further, traffic jam stage information 630 includes an identification of the current traffic jam stage 633 in traffic jam stages 631. In this illustrative example, timeline 632 can include stages that have passed as well as predictions for future stages in traffic jam stages 631.

For example, timeline 632 can be determined by time prediction module 635 based on time prediction module 635 using traffic data 560, historical traffic jam database 570, resolution information 609, transportation bureau traffic jam handling information 637, and medical rescue information 638 to determine timeline 632. In this example, transportation bureau traffic jam handling information 637 and medical rescue information 638 can be used to determine when different resources or services are activated to handle a traffic jam in response to an accident traffic jam or other type of traffic jam. In this example, this component can be implemented using a machine learning model, an expert system, or some other suitable process.

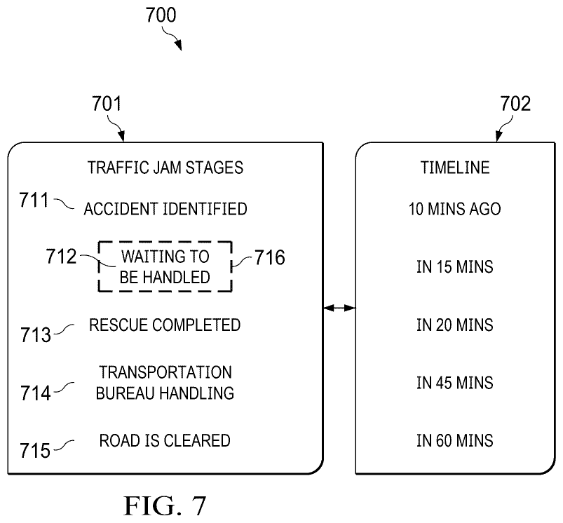

With reference next to FIG. 7, a block diagram of traffic jam stage information is depicted in accordance with an illustrative embodiment. In this illustrative example, traffic jam stage information 700 is an example of traffic jam stage information 600 in FIG. 6.

As depicted, traffic jam stage information 700 comprises traffic jam stages 701 and timeline 702. In this example, traffic jam stages 701 comprise five stages, including accident identified 711, waiting to be handled 712, rescue completed 713, transportation bureau handling 714, and road is cleared 715. In this example, current traffic jam stage 716 is graphically indicated as waiting to be handled 712.

In this example, timeline 702 indicates when a particular stage in traffic jam stages 701 has occurred or when a stage is predicted to occur. For example, accident identified 711 has occurred 10 minutes ago; waiting to be handled 712 is predicted to occur in 15 minutes; rescue completed 713 is predicted to occur in 20 minutes; transportation bureau handling 714 is predicted to occur in 45 minutes; and road cleared 715 is predicted to occur in 60 minutes. This type of information can be useful to drivers selecting a route from the route guidance. In this example, the traffic jam is early in the stages and selecting another route is likely to reduce the amount of time needed to reach the destination as compared to remaining on the current route in which the traffic jam is located. If the road is to be cleared in about 5 minutes, the traffic jam may clear up sufficiently such that the driver desires to stay on the current route to reach the destination.

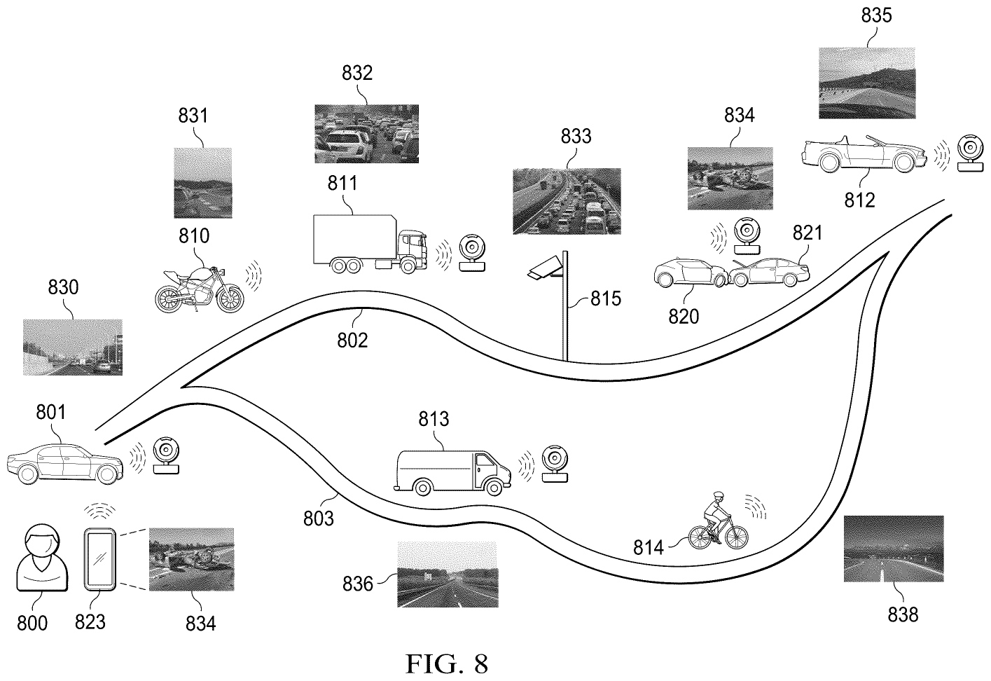

Turning next to FIG. 8, an illustration of real-time traffic information is depicted in accordance with an illustrative embodiment. In this illustrative example, driver 800 in automobile 801 is traveling to a destination that can be reached by traveling on one of road 802 and road 803.

As depicted, motorcycle 810, truck 811, and automobile 812 travel on road 802. Van 813 and bicycle 814 are vehicles that travel on road 803. Automobile 820 and automobile 821 have collided with each other and are causing a traffic jam on road 802. In this example, the different vehicles are Internet of Things vehicle (IoV) device. These vehicles can communicate with each other and the internet using IoV devices on these vehicles. Further, traffic camera 815 is located on road 802 and is an Internet of Things (IoT) device. In this example, all of the IoT devices have cameras except for motorcycle 810 and bicycle 814. These cameras can automatically generate images in real time and transmit those images for use by traffic analyzer 214 to perform analysis of traffic in real time.

In this example, these images include image 830, image 831, image 832, image 833, image 834, and image 835, which are images of road 802. Image 836 and image 838 are images of road 803. As depicted, these images show traffic on different portions of these roads. These images are sent to traffic analyzer 214, which can form an analysis of the images to identify the accident between automobile 820 and automobile 821. Further, the analysis of these images by traffic analyzer 214 can also identify the amount of traffic congestion along different locations on these roads.

Normally the speeds for traveling on road 802 are faster than road 803. In this example, automobile 801 can only travel the speed of 20 km/hr and is 30 kms away from the destination using this road. As a result, reaching the destination on road 802 is predicted to take 1.5 hours. Automobile 801 can travel at a speed of 60 km/hr traveling taking this road and the distance to the destination is 80 km. However, the prediction is that the destination can be reached in 1.33 hours even though the distance is farther. As a result, the accident makes using road 803 a better choice to reach the destination in a shorter period of time.

In this illustrative example, these types of decisions can be made by driver 800 with traffic analyzer 214 sending a map and route guidance to mobile phone 823. The map can include a visualization of this accident and the road conditions along both roads. In this illustrative example, this visualization can be the images generated in real time by the different Internet of Things devices. As depicted in this example, image 834 is displayed by mobile phone 823 to driver 800. Other real-time images along these roads at some chosen distance interval can be displayed to driver 800 for use in making a decision as to which road to take. Further, traffic analyzer 214 can also send traffic jam stage information that provides information about the stage and predicted stages for the accident between automobile 820 and automobile 821.

Thus, with this information, driver 800 has more information to make a determination as to which road to take to reach the destination. These visualizations can provide information in a manner that is easier to understand without needing to read text or interpret graphical elements indicating different traffic situations.

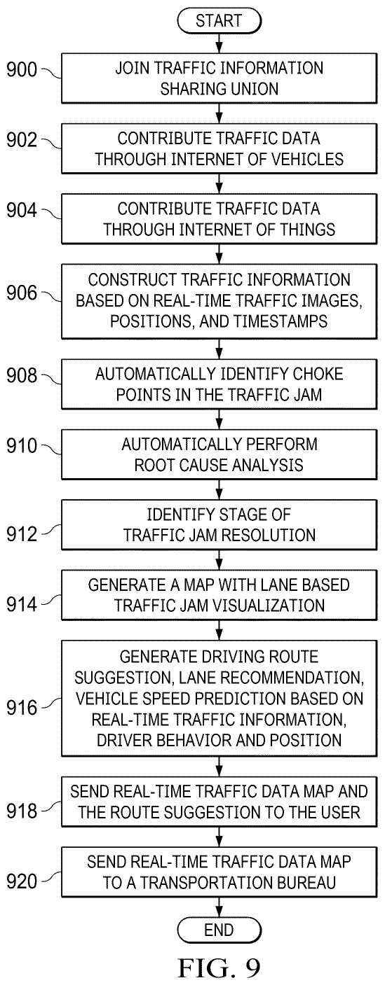

Turning now to FIG. 9, a flowchart of a workflow for traffic analysis is depicted in accordance with an illustrative embodiment. In this example, this workflow can be performed by traffic analysis system 202, driver 238, and transportation bureau 260 in FIG. 2.

The process begins by a user joining the traffic sharing union (step 900). In step 900, this user can be a driver or passenger in a vehicle. By joining this union, traffic information including traffic images can be shared. The user contributes traffic data through an Internet of Vehicles (step 902). In this example, the Internet of Vehicles is the group of vehicles sharing traffic information in the union. This information is also shared with the traffic analyzer.

The process also contributes traffic data through an Internet of Things (step 904). In step 904, the Internet of Things includes other devices in addition to the vehicles in the Internet of Vehicles. For example, images and other traffic data can be collected and shared by at least one of a traffic camera, an electronic toll collection (ETC) device, a streetlight, a digital sign, a roadside sensor, or other Internet of Things device that may not be a vehicle.

The process constructs traffic information using real-time traffic images, positions, and timestamps (step 906). In step 906, the positions and timestamps are associated with the real-time traffic images.

The process automatically identifies choke points in the traffic jam (step 908). One or more choke points can be present. In this example, the identification can be performed using a machine learning model or a vision analysis process such as an image recognition system or a computer vision system. The process automatically performs a root cause analysis (step 910). This analysis is performed to identify the root cause for the traffic jam. This analysis can be performed using a multiple classification algorithm in these examples.

The process identifies a stage of traffic jam resolution (step 912). The process generates a map with a lane based traffic visualization (step 914). In step 914, the map with the lane based visualization is generated using real time updates and a root cause analysis. The process generates a driving route suggestion, a lane recommendation, and a vehicle speed prediction based on real-time traffic information, driver behavior and position (step 916). In this example, the position of the vehicle is the position in which the driver is located. In this example, the lane recommendation can be part of the route suggestion.

The process sends the real time traffic data map and the route suggestion recommendation to the user (step 918). The process sends the real time traffic data map to a transportation bureau (step 920). The process terminates thereafter.

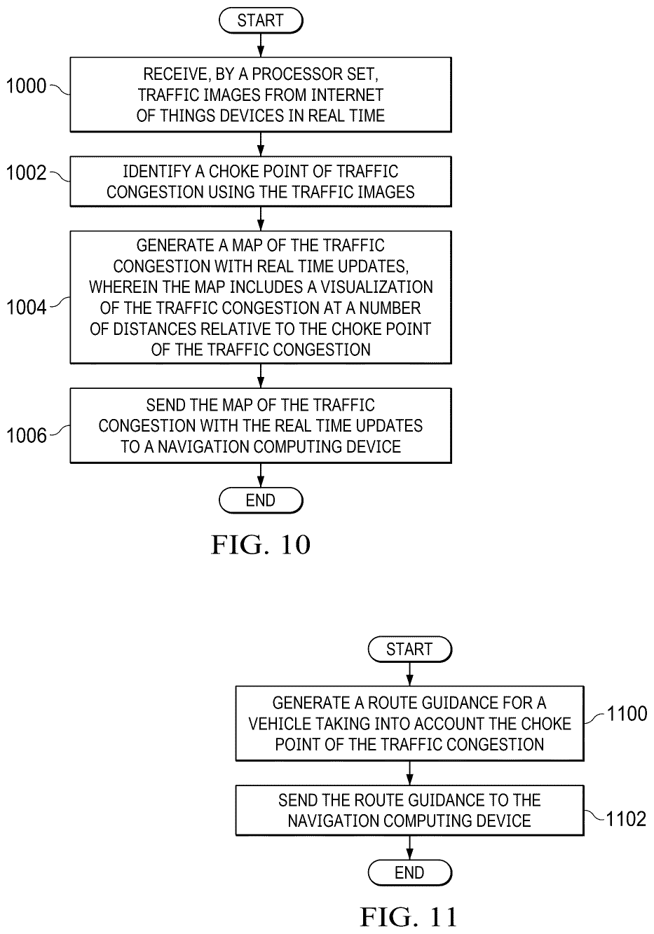

Turning next to FIG. 10, a flowchart of a process for analyzing traffic is depicted in accordance with an illustrative embodiment. The process in FIG. 10 can be implemented in hardware, software, or both. When implemented in software, the process can take the form of program instructions that are run by a processor set located in one or more hardware devices in one or more computer systems. For example, the process can be implemented in traffic analyzer 214 in computer system 212 in FIG. 2.

The process begins by receiving, by a processor set, traffic images from Internet of Things devices in real time (step 1000). The process identifies a choke point of traffic congestion using the traffic images (step 1002).

The process generates a map of the traffic congestion with real time updates, wherein the map includes a visualization of the traffic congestion at a number of distances relative to the choke point of the traffic congestion (step 1004). The process sends the map of the traffic congestion with the real time updates to a navigation computing device (step 1006). The process terminates thereafter. In step 1006, the map is an example of map 228 in FIG. 2.

With reference now to FIG. 11), a flowchart of a process for generating route guidance is depicted in accordance with an illustrative embodiment. This process is an example of additional steps that can be performed with the process in FIG. 10.

The process generates a route guidance for a vehicle taking into account the choke point of the traffic congestion (step 1100). The process sends the route guidance to the navigation computing device (step 1102). The process terminates thereafter.

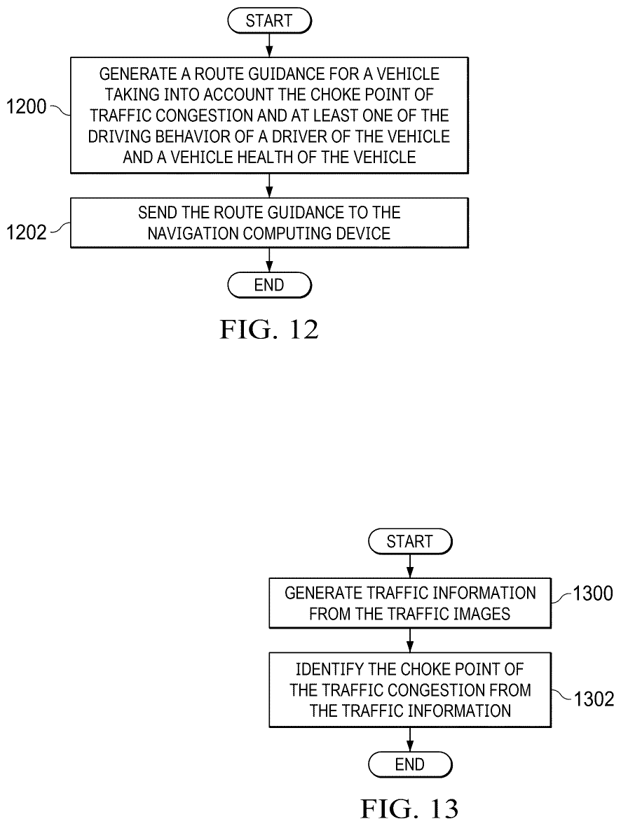

With reference next to FIG. 12, a flowchart of a process for generating route guidance is depicted in accordance with an illustrative embodiment. This process is an example of additional steps that can be performed with the process in FIG. 10.

The process generates a route guidance for a vehicle taking into account the choke point of the traffic congestion and at least one of driving behavior of a driver of the vehicle and a vehicle health of the vehicle (step 1200). The process sends the route guidance to the navigation computing device (step 1202). The process terminates thereafter.

With reference next to FIG. 13, a flowchart of a process for identifying a choke point of the traffic congestion is depicted in accordance with an illustrative embodiment. This process is an example of an implementation for step 1002 in FIG. 10.

The process generates traffic information from the traffic images (step 1300). The process identifies the choke point of the traffic congestion from the traffic information (step 1302). The process terminates thereafter.

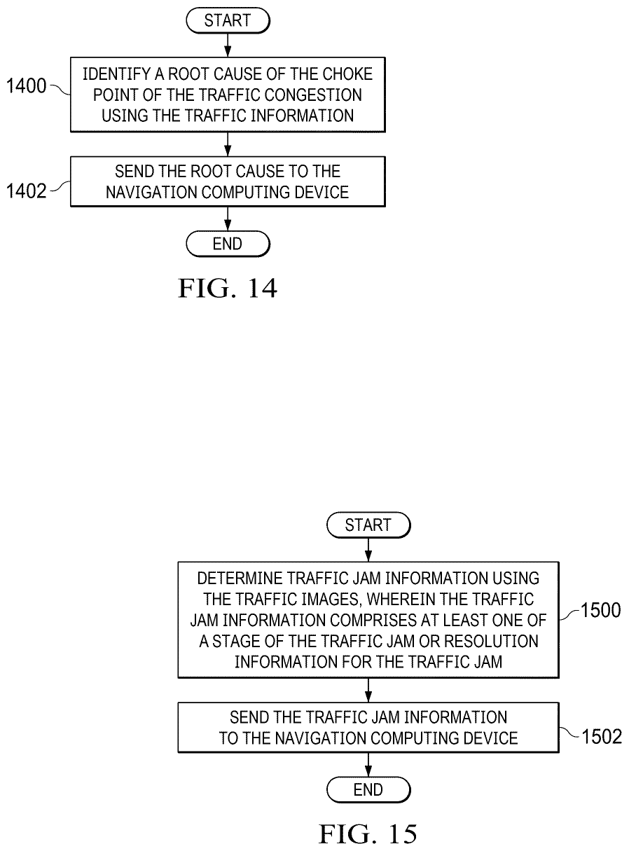

With reference now to FIG. 14, a flowchart of a process for identifying a root cause of the choke point of the traffic congestion route guidance is depicted in accordance with an illustrative embodiment. This process is an example of additional steps that can be performed with the process in FIG. 13.

The process identifies a root cause of the choke point of the traffic congestion using the traffic information (step 1400). The process sends the root cause to the navigation computing device (step 1402). The process terminates thereafter.

In FIG. 15, a flowchart of a process for determining traffic jam information is depicted in accordance with an illustrative embodiment. This process is an example of additional steps that can be performed with the process in FIG. 10.

The process determines traffic jam information using the traffic images, wherein the traffic jam information comprises at least one of a stage of the traffic jam or resolution information for the traffic jam (step 1500). The process sends the traffic jam information to the navigation computing device (step 1502). The process terminates thereafter.

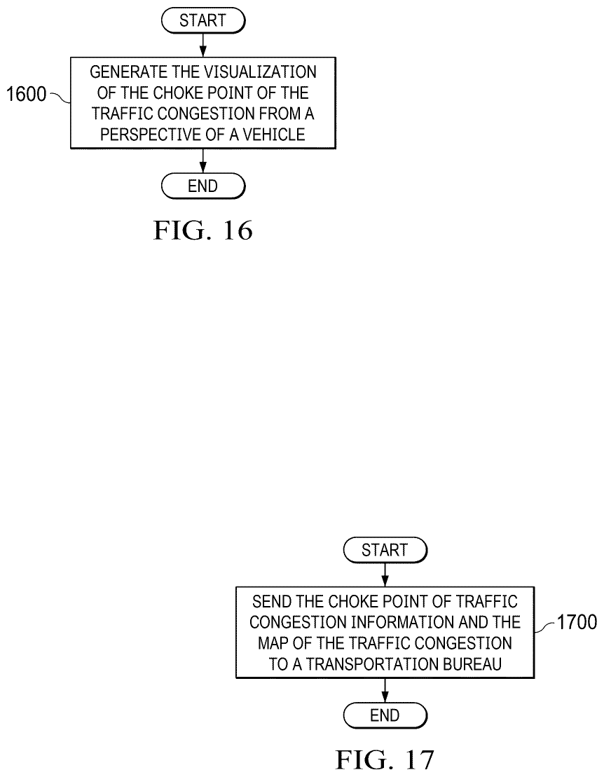

With reference next to FIG. 16, a flowchart of a process for generating a visualization is depicted in accordance with an illustrative embodiment. This process is an example of an additional step that can be performed with the process in FIG. 10. In this example, the traffic congestion is a traffic jam.

The process generates the visualization of the choke point of the traffic congestion from a perspective of a vehicle (step 1600). The process terminates thereafter.

Next in FIG. 17, a flowchart of a process for sending traffic congestion information is depicted in accordance with an illustrative embodiment. This process is an example of an additional step that can be performed with the process in FIG. 10. In this example, the traffic congestion is a traffic jam.

The process sends the choke point of the traffic congestion information and the map of the traffic congestion to a transportation bureau (step 1700). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

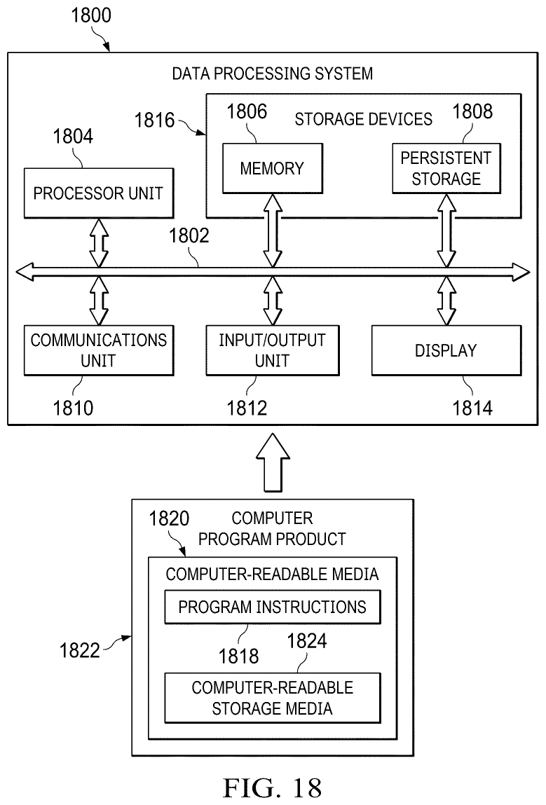

Turning now to FIG. 18, a block diagram of a data processing system is depicted in accordance with an illustrative embodiment. Data processing system 1800 can be used to implement computers and computing devices in computing environment 100 in FIG. 1. Data processing system 1800 can also be used to implement computer system 212 in FIG. 2. In this illustrative example, data processing system 1800 includes communications framework 1802, which provides communications between processor unit 1804, memory 1806, persistent storage 1808, communications unit 1810, input/output (I/O) unit 1812, and display 1814. In this example, communications framework 1802 takes the form of a bus system.

Processor unit 1804 serves to execute instructions for software that can be loaded into memory 1806. Processor unit 1804 includes one or more processors. For example, processor unit 1804 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1804 can be implemented using one or more heterogeneous processor systems in which a main processor is present with secondary processors on a single chip. As another illustrative example, processor unit 1804 can be a symmetric multi-processor system containing multiple processors of the same type on a single chip.

Memory 1806 and persistent storage 1808 are examples of storage devices 1816. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1816 may also be referred to as computer-readable storage devices in these illustrative examples. Memory 1806, in these examples, can be, for example, a random-access memory or any other suitable volatile or non-volatile storage device. Persistent storage 1808 may take various forms, depending on the particular implementation.

For example, persistent storage 1808 may contain one or more components or devices. For example, persistent storage 1808 can be a hard drive, a solid-state drive (SSD), a flash memory, a rewritable optical disk, a rewritable magnetic tape, or some combination of the above. The media used by persistent storage 1808 also can be removable. For example, a removable hard drive can be used for persistent storage 1808.

Communications unit 1810, in these illustrative examples, provides for communications with other data processing systems or devices. In these illustrative examples, communications unit 1810 is a network interface card.

Input/output unit 1812 allows for input and output of data with other devices that can be connected to data processing system 1800. For example, input/output unit 1812 may provide a connection for user input through at least one of a keyboard, a mouse, or some other suitable input device. Further, input/output unit 1812 may send output to a printer. Display 1814 provides a mechanism to display information to a user.

Instructions for at least one of the operating system, applications, or programs can be located in storage devices 1816, which are in communication with processor unit 1804 through communications framework 1802. The processes of the different embodiments can be performed by processor unit 1804 using computer-implemented instructions, which may be located in a memory, such as memory 1806.

These instructions are referred to as program instructions, computer usable program instructions, or computer-readable program instructions that can be read and executed by a processor in processor unit 1804. The program instructions in the different embodiments can be embodied on different physical or computer-readable storage media, such as memory 1806 or persistent storage 1808.

Program instructions 1818 are located in a functional form on computer-readable media 1820 that is selectively removable and can be loaded onto or transferred to data processing system 1800 for execution by processor unit 1804. Program instructions 1818 and computer-readable media 1820 form computer program product 1822 in these illustrative examples. In the illustrative example, computer-readable media 1820 is computer-readable storage media 1824.

Computer-readable storage media 1824 is a physical or tangible storage device used to store program instructions 1818 rather than a medium that propagates or transmits program instructions 1818. Computer-readable storage media 1824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1818 can be transferred to data processing system 1800 using a computer-readable signal media. The computer-readable signal media are signals and can be, for example, a propagated data signal containing program instructions 1818. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1820” can be singular or plural. For example, program instructions 1818 can be located in computer-readable media 1820 in the form of a single storage device or system. In another example, program instructions 1818 can be located in computer-readable media 1820 that is distributed in multiple data processing systems. In other words, some instructions in program instructions 1818 can be located in one data processing system while other instructions in program instructions 1818 can be located in one data processing system. For example, a portion of program instructions 1818 can be located in computer-readable media 1820 in a server computer while another portion of program instructions 1818 can be located in computer-readable media 1820 located in a set of client computers.

The different components illustrated for data processing system 1800 are not meant to provide architectural limitations to the manner in which different embodiments can be implemented. In some illustrative examples, one or more of the components may be incorporated in or otherwise form a portion of, another component. For example, memory 1806, or portions thereof, may be incorporated in processor unit 1804 in some illustrative examples. In other examples, more than one processor unit can be present. The different illustrative embodiments can be implemented in a data processing system including components in addition to or in place of those illustrated for data processing system 1800. Other components shown in FIG. 18 can be varied from the illustrative examples shown. The different embodiments can be implemented using any hardware device or system capable of running program instructions 1818.

Thus, illustrative embodiments of the present invention provide a computer implemented method, computer system, and computer program product for analyzing traffic. The analysis can provide information used by drivers to select routes in a manner that reduces issues from traffic congestion such as traffic jams.

In one illustrative example, a computer implemented method analyzes traffic. A processor set receives traffic images from Internet of Things devices in real time. The processor set identifies a choke point of traffic congestion using the traffic images. The processor set generates a map of the traffic congestion with real time updates, wherein the map includes a visualization of the traffic congestion at a number of distances relative to the choke point of the traffic congestion. The processor set sends the map of the traffic congestion with the real time updates to a navigation computing device.

In the illustrative example, the root cause of congestion such as a traffic jam along with the chokepoint can be provided to the driver. This information can be used to adjust the lane in which the driver is using or take another action such as changing routes.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for analyzing traffic, the computer implemented method comprising:
receiving, by a processor set, traffic images from Internet of Things devices in real time; and
identifying, by the processor set, a choke point of traffic congestion using the traffic images;
generating, by the processor set, a map of the traffic congestion with real time updates, wherein the map includes a visualization of the traffic congestion at a number of distances relative to the choke point of the traffic congestion; and
sending, by the processor set, the map of the traffic congestion with the real time updates to a navigation computing device.

2. The computer implemented method of claim 1 further comprising:
generating, by the processor set, a route guidance for a vehicle taking into account the choke point of the traffic congestion; and
sending the route guidance to the navigation computing device.

3. The computer implemented method of claim 1 further comprising:
generating, by the processor set, a route guidance for a vehicle taking into account the choke point of the traffic congestion and at least one of driving behavior of a driver of the vehicle and a vehicle health of the vehicle; and
sending, by the processor set, the route guidance to the navigation computing device.

4. The computer implemented method of claim 1, wherein identifying, by the processor set, the choke point of the traffic congestion comprises:
generating, by the processor set, traffic information from the traffic images; and
identifying, by the processor set, the choke point of the traffic congestion from the traffic information.

5. The computer implemented method of claim 4 further comprising:
identifying, by the processor set, a root cause of the choke point of the traffic congestion using the traffic information; and
sending, by the processor set, the root cause to the navigation computing device.

6. The computer implemented method of claim 1, wherein the traffic congestion is a traffic jam and further comprising:
determining, by the processor set, traffic jam information using the traffic images, wherein the traffic jam information comprises at least one of a stage of the traffic jam or resolution information for the traffic jam; and
sending the traffic jam information to the navigation computing device.

7. The computer implemented method of claim 6 further comprising:
generating, by the processor set, the visualization of the choke point of the traffic congestion from a perspective of a vehicle.

8. The computer implemented method of claim 1 further comprising:
sending, by the processor set, the choke point of the traffic congestion information and the map of the traffic congestion to a transportation bureau.

9. A computer system comprising:
a processor set;
a set of one or more computer-readable storage media; and
program instructions, collectively stored in the set of one or more storage media, for causing the processor set to perform the following computer operations:
receive traffic images from Internet of Things devices in real time;
identify a choke point of traffic congestion using the traffic images;
generate a map of the traffic congestion with real time updates, wherein the map includes a visualization of the traffic congestion at a number of distances relative to the choke point of the traffic congestion; and
send the map of the traffic congestion with the real time updates to a navigation computing device.

10. The computer system of claim 9, wherein the program instructions, collectively stored in the set of one or more storage media, further causes the processor set to perform the following computer operations:
generate a route guidance for a vehicle taking into account the choke point of the traffic congestion; and
send the route guidance to the navigation computing device.

11. The computer system of claim 9, wherein the program instructions, collectively stored in the set of one or more storage media, further causes the processor set to perform the following computer operations:
generate a route guidance for a vehicle taking into account the choke point of the traffic congestion and at least one of driving behavior of a driver of the vehicle and a vehicle health of the vehicle; and
send the route guidance to the navigation computing device.

12. The computer system of claim 9, wherein as part of identifying the choke point of the traffic congestion, the program instructions, collectively stored in the set of one or more storage media, causes the processor set to perform the following computer operations:
generate traffic information from the traffic images; and
identify the choke point of the traffic congestion from the traffic information.

13. The computer system of claim 12, further comprising:
identify a root cause of the choke point of the traffic congestion using the traffic information; and
send the root cause to the navigation computing device.

14. The computer system of claim 9, wherein the traffic congestion is a traffic jam and, wherein the program instructions, collectively stored in the set of one or more storage media, further causes the processor set to perform the following computer operations:
determine traffic jam information using the traffic images, wherein the traffic jam information comprises at least one of a stage of the traffic jam or resolution information for the traffic jam; and
send the traffic jam information to the navigation computing device.

15. The computer system of claim 14, wherein the program instructions, collectively stored in the set of one or more storage media, further causes the processor set to perform the following computer operations:
generate the visualization of the choke point of the traffic congestion from a perspective of a vehicle.

16. The computer system of claim 14, wherein the program instructions, collectively stored in the set of one or more storage media, further causes the processor set to perform the following computer operations:
send the choke point of the traffic congestion information and the map to a transportation bureau.

17. A computer program product for analyzing traffic, the computer program product comprising:
a set of one or more computer-readable storage media; and
program instructions, collectively stored in the set of one or more storage media, for causing a processor set to perform the following computer operations:
receive traffic images from Internet of things devices in real time;
identify a choke point of traffic congestion using the traffic images;
generate a map of the traffic congestion with real time updates, wherein the map includes a visualization of the traffic congestion at a number of distances relative to the choke point of the traffic congestion; and
send the map of the traffic congestion with the real time updates to a navigation computing device.

18. The computer program product of claim 17, wherein the program instructions, collectively stored in the set of one or more storage media further cause the processor set to perform the following computer operations:
generate a route guidance for a vehicle taking into account the choke point of the traffic congestion; and
send the route guidance to the navigation computing device.

19. The computer program product of claim 17, wherein the program instructions, collectively stored in the set of one or more storage media further cause the processor set to perform the following computer operations:
generate a route guidance for a vehicle taking into account the choke point of the traffic congestion and at least one of driving behavior of a driver of the vehicle and a vehicle health of the vehicle; and
send the route guidance to the navigation computing device.

20. The computer program product of claim 17, wherein as part of identifying the choke point of the traffic congestion, the program instructions, collectively stored in the set of one or more storage media, causes the processor set to perform the following computer operations:
generate traffic information from the traffic images; and
identify the choke point of the traffic congestion from the traffic information.
